(19) United States
(12) Patent Application Publication
(10) Pub. No.: US 2014/0373443 A1
(43) Pub. Date: Dec. 25, 2014

(54) PLANT CULTIVATION BAG STRUCTURE

(71) Applicants: CHIN-MIN LIU, HSINCHU COUNTY (TW); HSUEH-CHIH LIU, HSINCHU COUNTY (TW)

(72) Inventors: CHIN-MIN LIU, HSINCHU COUNTY (TW); HSUEH-CHIH LIU, HSINCHU COUNTY (TW)

(21) Appl. No.: 13/924,756

(22) Filed: Jun. 24, 2013

(51) Int. Cl. A01G 9/02

(52) U.S. Cl. CPC A01G 9/022
USPC 47/65.8

(57) ABSTRACT

A plant cultivation bag structure, comprising: at least a thin main body, with its top portion provided with a hanging piece; and a plurality of bag bodies, arranged in partition on said thin main body, by means of Thermal Pressing, High Frequency Fusion, Ultra-Sonic Fusion. Inside the bag body is provided with a receiving space, with its lower portion having at least a flow guiding hole. Through using the flow guiding hole to connect each bag body, irrigation of plants can be simplified. Through guiding water using the bag body itself, no water dripping nor the ensuing noise would occur. As such, it will not affect sound sleep of people, even when it is placed in bedroom as a plant wall or a window farm. It can be hung on a wall or a window or form into a stand-up curtain to save space.

### BACKGROUND OF THE INVENTION

1. Field of the Invention

The present invention relates to a plant cultivation structure, and in particular to a bag shape plant cultivation device, that can be hung on a wall, a window, or be a stand-up curtain, to form a plant wall, window farm, or curtain of a plant cultivation bag structure.

2. The Prior Arts

Plants are closely related to our daily life, and they play an important role in the various circulations of the ecological system (for example, nitrogen circulation, carbon circulation, oxygen circulation etc.). Meanwhile, quite a lot of researches indicate that plants could have positive impact on the physiology and psychology of the people. Therefore, in recent years, the promotion of green environment is getting more and more attention.

In general, the promotion of green environment is realized in public places and open environment, such as streets and parks. Also, it can be realized in our daily life and working environment. For example, plant wall can be placed on a terrace, in a bed room, or in an office to beautify the environment, to relieve pressure in our work and life, and to create an atmosphere of comfortable living.

Presently, a plant wall is formed by placing the plants into a vessel, then hang the vessels on a wall, to achieve the purpose of beautifying the environment. Though the plant wall can give a sense of beauty, by a large number of plants placed thereon, yet it occupies a rather large area, requiring quite a lot of components, not easy to install and move, thus the technical barrier of realizing it is pretty high. In addition, for the large number of plants cultivated, the irrigation is difficult and tedious, for it requires to irrigate the plants one by one. The objective of setting up the plant wall is to relieve the pressure of life, yet in case its irrigation becomes a source of pressure, then its existence is not worthwhile. Or even the irrigation system does exist, but if it adopts a water dripping irrigation, the noise caused by water dripping could devoid people of a sound sleep.

Presently, the window farm is formed by placing plants in a plurality of vessels, and then they are hung on the side of a window, and its irrigation is done by water dripping pipes between vessels. Though, the window farm can serve the purpose of cultivating plants, yet it requires quite a lot of components. Its irrigation is complicated, when the plant wall is placed in a bed room, during irrigation, noise tends to occur for the pipe dropping water between vessels, to affect the sound sleep of people. On the other hand, the stand-up curtain can only provide light shielding effect, and it does not have the functions of cultivating green plants to purify the air.

Therefore, presently, the design and performance of the plant wall is not quite satisfactory, and it has much room for improvements.

### SUMMARY OF THE INVENTION

In view of the problems and drawbacks of the prior art, the present invention provides a plant cultivation bag structure, to effectively overcome the problems and shortcomings of the prior art.

A major objective of the present invention is to provide a plant cultivation bag structure, that can be hung from a wall or window, to form a plant wall or window farm, or a curtain, to reduce cultivation space required and beautify the environment. Due to the design of the flow guiding hole, the irrigation is simplified, and through the guiding of the bag body itself, noise would not occur during irrigation. Therefore, even the plant wall or window farm is placed in a bed room, it would not affect the sound sleep of people.

Another objective of the present case is to provide a plant cultivation bag structure, that can be hung on a window to become a stand-up curtain, to shield the sunlight from getting in the room, and to utilize the sunlight effectively to provide a green environment.

A yet another objective of the present invention is to provide a plant cultivation bag structure, that is simple in construction, easy to produce, of low cost, and having high production efficiency.

In order to achieve the above mentioned objective, the present invention provides a plant cultivation bag structure, including: at least a thin main body, with its top portion provided with a hanging piece. On the thin main body is provided with a plurality of bag bodies arranged in equal spacing. Inside the bag body is provided with a receiving space, with its low rim provided with at least a flow guiding hole.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a front view of the plant cultivation bag structure according to the first embodiment of the present invention;

FIG. 2 is a side cross section view of the plant cultivation bag structure according to the first embodiment of the present invention;

FIG. 3 is a front view of the plant cultivation bag structure according to the second embodiment of the present invention;

FIG. 4 is a side cross section view of the plant cultivation bag structure according to the third embodiment of the present invention;

FIG. 5 is a front view of the plant cultivation bag structure according to the fourth embodiment of the present invention;

FIG. 6 is a front view of the plant cultivation bag structure according to the fifth embodiment of the present invention;

FIG. 7 is a front view of the plant cultivation bag structure according to the sixth embodiment of the present invention;

FIG. 8 is a front view of the plant cultivation bag structure according to the seventh embodiment of the present invention;

FIG. 9 is a front view of the plant cultivation bag structure according to the eighth embodiment of the present invention;

FIG. 10 is a schematic diagram of a plant cultivation bag structure according to the ninth embodiment when it is in usage; and

FIG. 11 is a schematic diagram of a plant cultivation bag structure according to the tenth embodiment when it is in usage.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

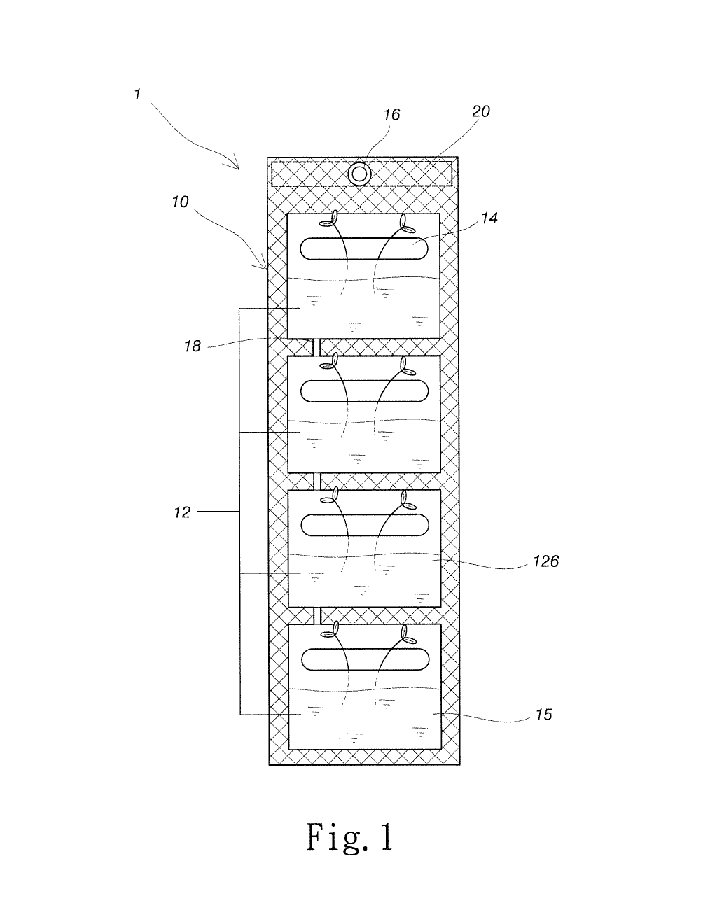

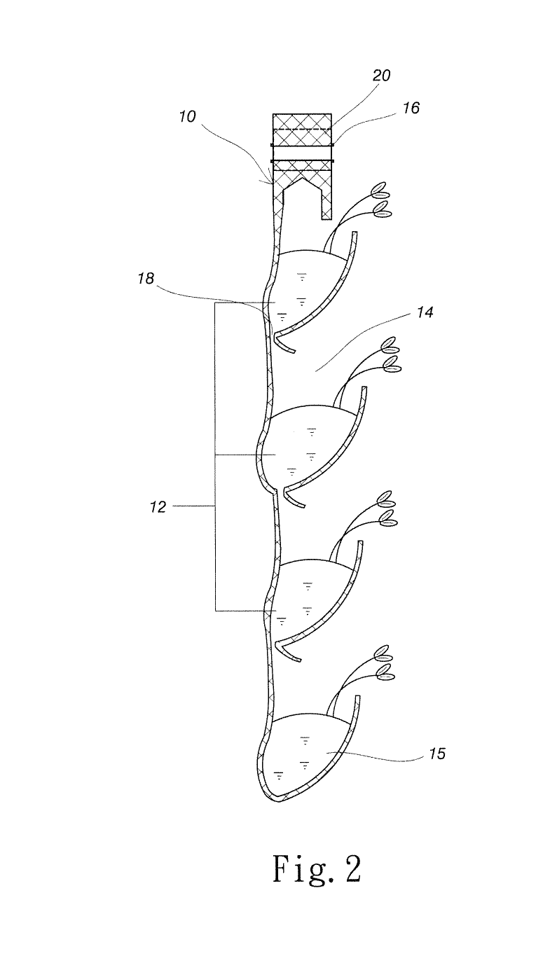

Refer to FIGS. 1 and 2 respectively for a front view and a side cross section view of the plant cultivation bag structure according to the first embodiment of the present invention. As shown in FIGS. 1 and 2, the plant cultivation bag structure includes a thin main body 10, on which is arranged in partition a plurality of bag bodies U. The thin main body 10 and bag body 12 are made of plastic material, or composite reinforced material containing fiber, resin, or aluminum foil. Thermal Pressing, High Frequency Fusion, Ultra-Sonic Fusion, Stick methods are used to partition the thin main body 10 into a plurality of bag bodies 12. In the bag body 12 is provided with a receiving space to accommodate the cultivation soil, irrigation water. Usually, when it is finished producing, the bag body 12 is empty, for the user to put in seed and cultivation soil; or alternatively, when it is finished producing, the bag body 12 is filled with seed and cultivation soil. The bag body 12 may not be provided with an opening, when the user desires to put in plants, the user may use a knife to cut an opening on the top portion of the bag body 12. Or, as shown in Figs. I and 2, when it is finished producing, on top of one side of the bag body 12 is provided with an opening 14. The opening 14 may be sealed with a film, and that can be torn open, when the user desires to use the bag body 12. The opening 14 can be a machine sewing thread or a press mark thread, so that the user can tear it open, when he desires to use the bag body 12.

On top of the thin main body 10 is a hanging piece 16 of a ring shape, for the outside hook (not shown) to pass through the hanging piece 16, for the thin main body 10 to hang on. In addition to being a ring shape, the hanging piece 16 can also be a strap shape to hang the thin main body 10 directly onto a hook (not shown). The top of the thin main body 10 is further provided with a support piece 20, support piece 20 is of a long strap shape, to keep the thin main body 10 in shape.

On each of the bag bodies 12 is provided with a flow guiding hole 18, to connect to each bag body 12. As shown in FIG. 1, the flow guiding hole 18 is disposed between two adjacent bag bodies 12, to connect the receiving space of the two adjacent bag bodies 12. The bottom of the thin main body 10 is provided with a water-gathering bag body 15 without the flow guiding hole 18, to receive the water flowing out of the flow guiding hole 18 from the lowest bag body 126. The water-gathering bag body 15 may also be provided with an opening 14 to cultivate plants. Therefore, in irrigation or applying fertilizer, it only requires to do so from the uppermost bag body 12, so that water and liquid fertilizer may flow through the flow guiding holes 18 into the plurality of bag bodies 12 and the water-gathering bag body 15, thus it can save time and effort. In this approach, water and liquid fertilizer flow are guided by the bag body 12 itself, thus no water dripping would occur, in achieving noise less irrigation.

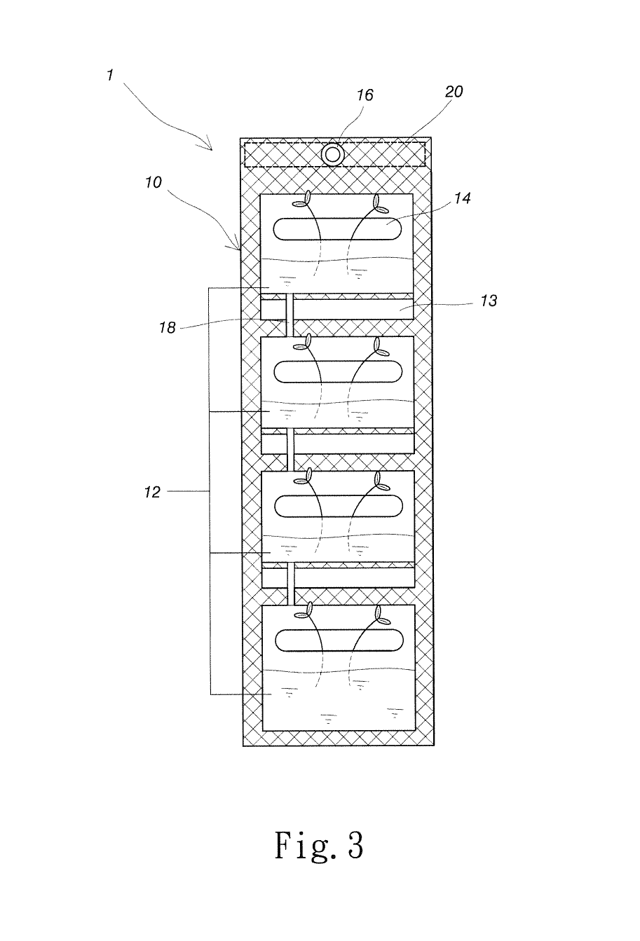

Next, refer to FIG. 3 for a front view of the plant cultivation bag structure according to the second embodiment of the present invention. As shown in FIG. 3, the structure of the second embodiment is the same as that of the first embodiment, and that will not be repeated here for brevity. The difference is that, in the second embodiment, a partition space 13 is provided between each bag body 12, so that the flow guiding hole 18 passes through the a partition space 13, and is connected to the receiving space of the adjacent bag body 12, to make water flow through each bag body 12. The partition space 13 can provide more growth space for the plant.

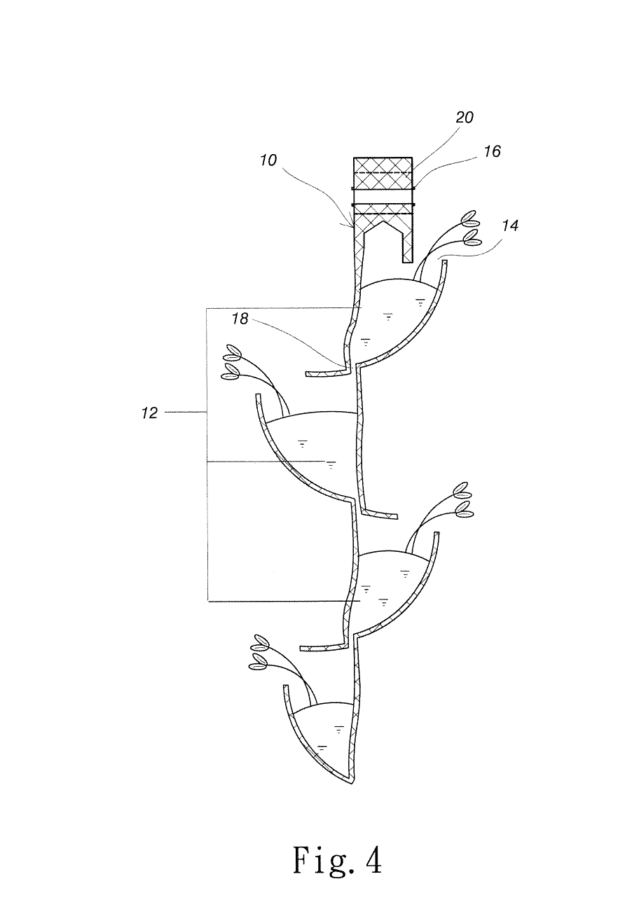

Then, refer to FIG. 4 for a front view of the plant cultivation bag structure according to the third embodiment of the present invention. As shown in FIG. 4, the structure of the third embodiment is the same as that of the second embodiment, and that will not be repeated here for brevity. The difference is that, in the third embodiment, the openings 14 are disposed alternatively on one side of the bag body 12, and on the other side of the adjacent bag body 12, so that the plant is able to grow out from the opening 14. In this approach, the plant may have more growing space, and it could also add aesthetics to this arrangement of the plant cultivation bag structures.

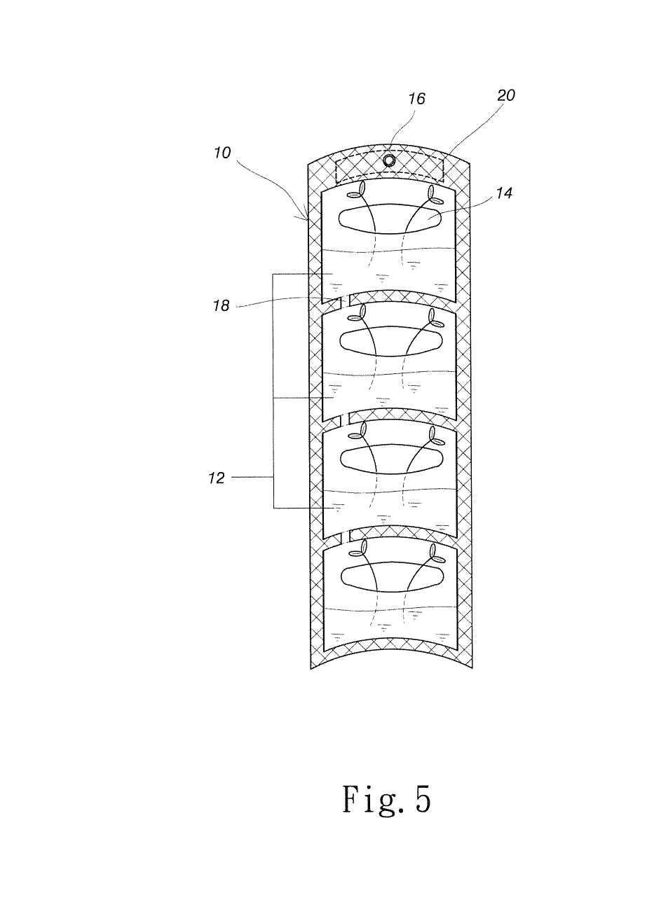

Subsequently, refer to FIG. 5 for a front view of the plant cultivation bag structure according to the fourth embodiment of the present invention. As shown in FIG. 5, the structure of the fourth embodiment is the same as that of the third embodiment, and that will not be repeated here for brevity. The difference is that, in the fourth embodiment, the support piece 20 is of an arc shape or a multi-section arc shape. In addition to keeping the thin main body 10 in shape, it can also stretch the bag body 12 to form a round shape similar to a potted plant, to avoid pressing and hurting the root of the plant, and be beneficial to the growth of the plant. The arc shape or multi-section arc shape may also stretch the opening 14 into shape, to be favorable for the plant to grow out of the opening 14. The support piece 20 may also be made into an L-bend shape, for the thin main body 10 to be bent into an L shape, to match the L shape of the corner of a wall, so as to install the plant cultivation bag structure 1 around the corner of a wall.

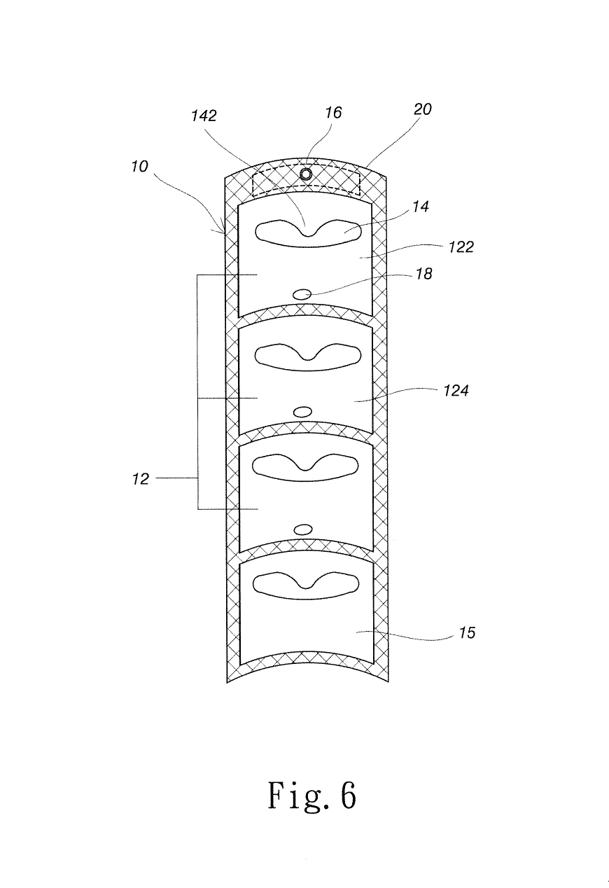

Subsequently, refer to FIG. 6 for a front view of the plant cultivation bag structure according to the fifth embodiment of the present invention. As shown in FIG. 6, the structure of the fifth embodiment is the same as that of the fourth embodiment, and that will not be repeated here for brevity. The difference is that, in the fifth embodiment, the flow guiding hole 18 in the bag body 12 is used to connect the receiving space of the bag body 12 to outside. Above the opening 14 is provided with a guiding portion 142 protruding from the opening 14. Since in addition to stretching out the opening 14 into shape, the arc shape or multi-section arc shape support piece 20 can also change the shape of the guiding portion 142, so that the guiding portion 142 is formed into an arc shape, to receive the water flowing out from the flow guiding hole 18 of the bag body 122, and guide the water to flow to the next bag body 124. Also, it guides the water to the root of the plant, so that water dripping and noise would not occur during irrigation. Moreover, when the opening 14 of the bag body 124 partitions along the thermal press junction of the bag body 122, since the arc shape or multi-section arc shape support piece 20 can stretch the opening 14 into shape, so it connects the receiving space of the bag body 12 and the flow guiding hole 18 of the outer space. Alternatively, the opening 14 may not be provided with a guiding portion 142. In this case, the water flowing out from flow guiding hole 18 of the bag body 122 flows into the opening 14 of the bag body 124 along the bag body 122.

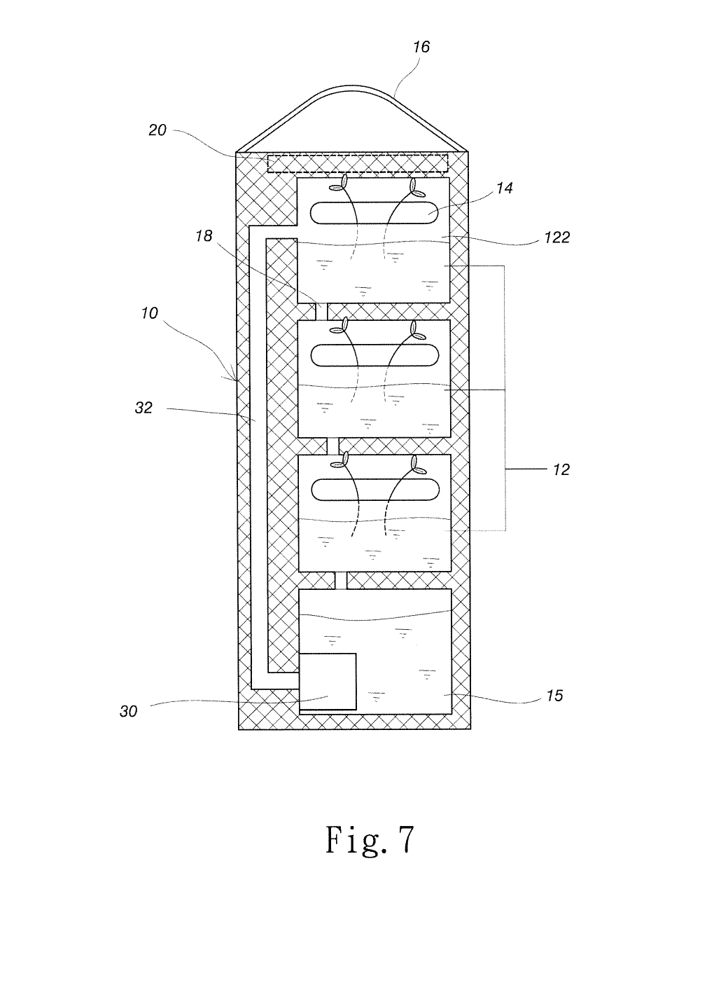

Then, refer to FIG. 7 for a front view of the plant cultivation bag structure according to the sixth embodiment of the present invention. As shown in FIG. 7, the structure of the sixth embodiment is the same as that of the fifth embodiment, and that will not be repeated here for brevity. The difference is that, in the sixth embodiment, the hanging piece 16 is the only strap shape object, for the plant cultivation bag structure 1 to hang onto a hanging hook (not shown). In the present embodiment, a water channel 32 is connected to the uppermost bag body 122 and the water-gathering bag body 15. In the water-gathering bag body 15 is provided with a water pump 30, with its outlet connected to the water channel 32. The thin main body 10 utilizes the water pump 30 to pump the water in the water-gathering bag body 15 to the uppermost bag body 122 through the water channel 32. Then, the water flows through the flow guiding hole 18 into each bag body 12. In the descriptions above, the pump 30 can be an air pump 30.

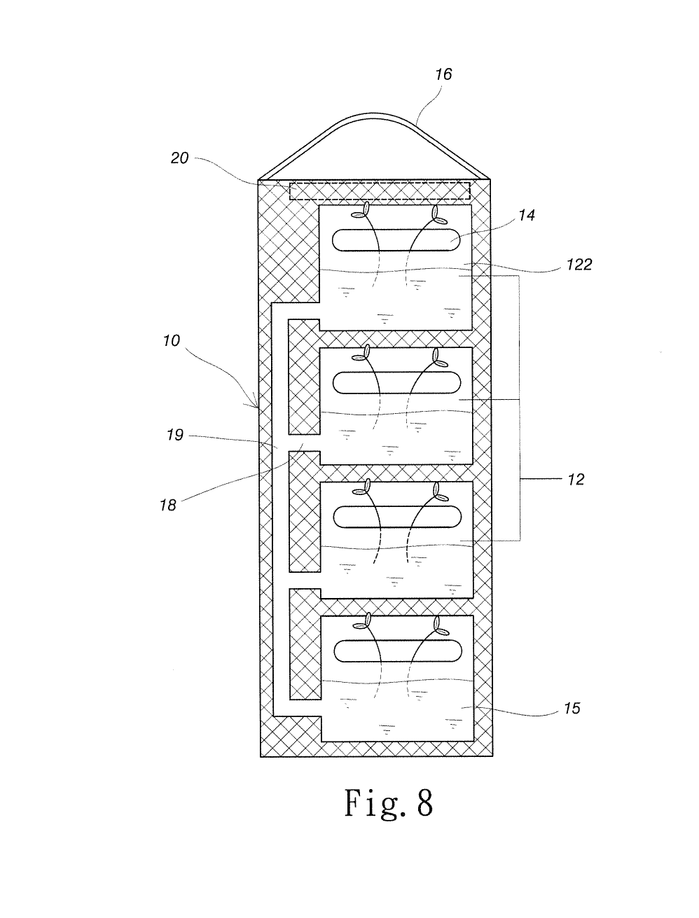

Subsequently, refer to FIG. 8 for a front view of the plant cultivation bag structure according to the seventh embodiment of the present invention. As shown in FIG. 8, the structure of the seventh embodiment is the same as that of the sixth embodiment, and that will not be repeated here for brevity. The difference is that, in the seventh embodiment, the hanging piece 16 is of a strap shape. The strap shape hanging piece 16 is used to hang the plant cultivation bag structure 1 into a hanging hook (not shown). The respective flow guiding holes 18 are connected to a common channel 19, so that the flow guiding holes 18 are connected to each other. As such, during irrigation, it only requires to pour water from the uppermost bag body 12, then water flows through the common channel 19 to each of the flow guiding holes 18, and then water and liquid fertilizer flow into the plurality of bag bodies 12. In this approach, irrigation time and effort are reduced. Also, in this design, the flow of water and liquid fertilizer in the water bag 12 is guided by the bag body 12 itself, such that the flow along the bag body 12 can avoid water dripping without causing noise, to achieve noise less irrigation.

In the bag body 12, in addition to a flow guiding hole 18 connected to the common channel 19, another flow guiding holes 18 can be provided to increase the water flow, and to speed up water flow to the plurality of bag bodies 12.

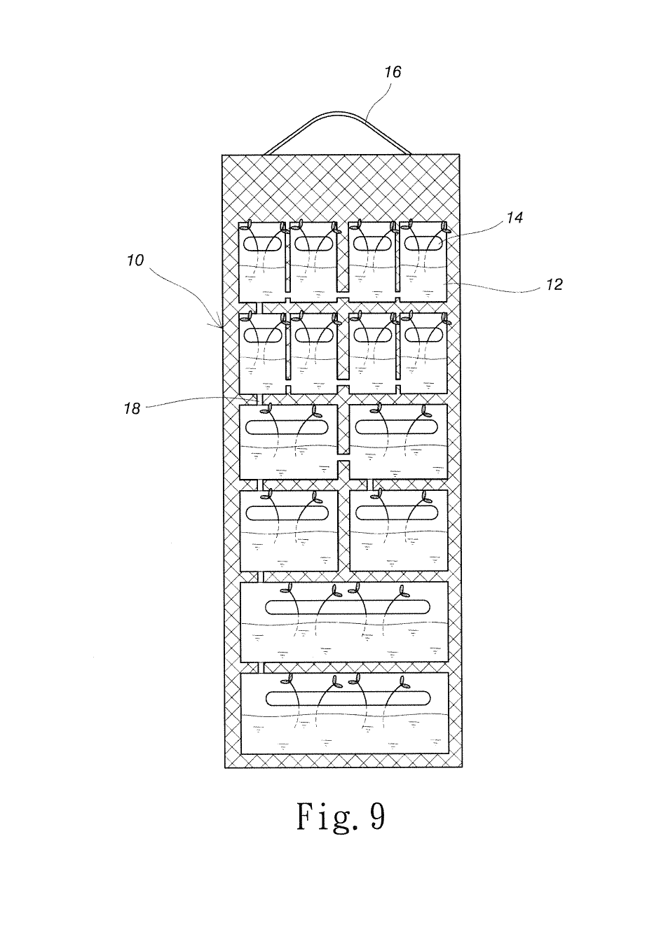

Then, refer to FIG. 9 for a front view of the plant cultivation bag structure according to the eighth embodiment of the present invention. As shown in FIG. 9, in the present embodiment, Thermal Pressing, High Frequency Fusion, Ultra-Sonic Fusion , Stick method are utilized to partition the thin main body 10 into bag bodies 12 of various sizes in a vertical or horizontal arrangement, to increase the diversity of the present invention. In this way of design, it can give a sense of beauty, due to the different sizes and arrangements of the bag bodies 12.

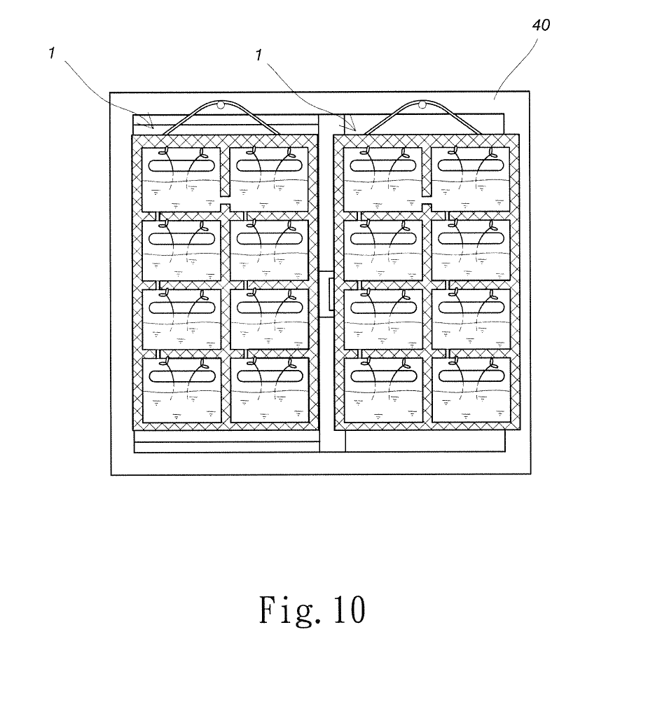

Moreover, refer to FIG. 10 for a schematic diagram of a plant cultivation bag structure according to the ninth embodiment when it is in usage. Wherein, it shows that, in addition to being hung on a wall to form a plant wall, the plant cultivation bag structure 1 can be hung on a window 40 to serve as a curtain. As such it can not only shield the sunlight penetrating through the window 40, but it can also use the sunlight effectively. In this way of design, the plant in the plant cultivation bag structure 1 performs photosynthesis using sunlight, to provide a green environment and fresh air, while achieving pleasant vision enjoyment.

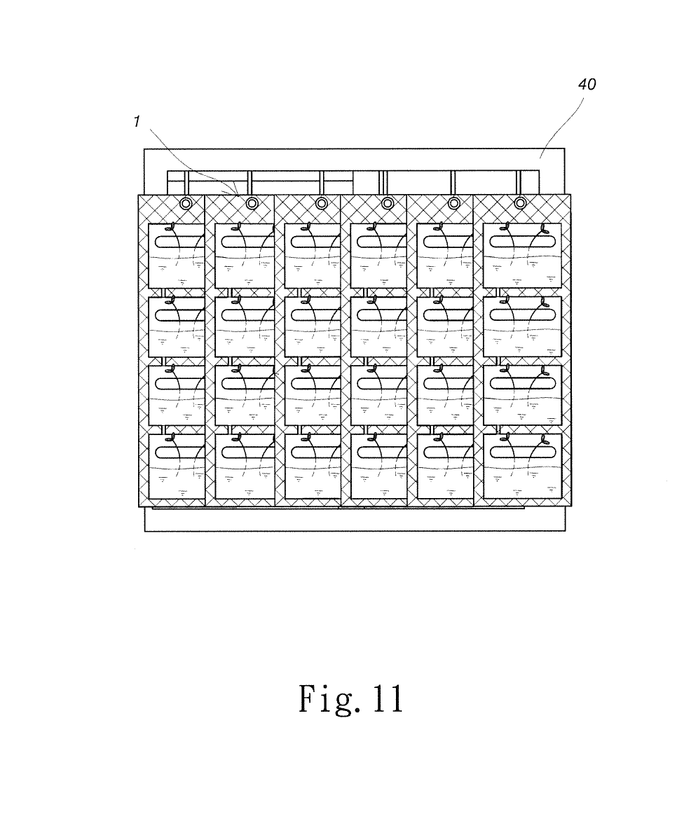

Finally, refer to FIG. 11 for a schematic diagram of a plant cultivation bag structure according to the tenth embodiment when it is in usage. Wherein, the plant cultivation bag structure 1 is not provided with water pipes connecting outside. The plant cultivation bag structure 1 is made into a stand-up shutter curtain to shield the sunlight penetrating through the window 40. The curtain of the shutter can be rotated to rotate the plant cultivation bag structure 1 to change its light receiving surface, to be favorable to the growth of the plant. As such, the plant in the plant cultivation bag structure 1 may use sunlight effectively to perform photosynthesis, to provide a green environment and fresh air, in achieving pleasant vision enjoyment.

Summing up the above, the plant cultivation bag structure of the present invention can be hung on a wall or a window, to form a plant wall, window farm, or a curtain, to save cultivation space and beautify the environment. Due to its design of flow guiding holes, the irrigation can be simplified. Also, through the guidance of water by the bag body itself, no water dripping would occur to produce noise, so that it would not affect the sound sleep of people, even when it is placed in a bed room. The plant cultivation bag structure can also be hung on a window to be a stand-up curtain, to shield the sunlight penetrating through the window, and utilize effectively the sunlight to perform photosynthesis, to provide a green environment and fresh air. The present invention is simple in construction, low in production cost, while achieving high production efficiency.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A plant cultivation bag structure, comprising:
at least a thin main body, with its top portion provided with a hanging piece; and
a plurality of bag bodies, arranged in partition on said thin main body, a receiving space is provided in said bag body, and lower edge of each said bag body is provided with at least a flow guiding hole.

2. The plant cultivation bag structure as claimed in claim 1, wherein near a top portion of each said bag body is provided with an opening.

3. The plant cultivation bag structure as claimed in claim 2, wherein said openings are disposed alternatively on one side of said bag body, and on other side of an adjacent bag body.

4. The plant cultivation bag structure as claimed in claim 2, wherein on said opening is provided with a seal film, to seal tightly said opening.

5. The plant cultivation bag structure as claimed in claim 2, wherein said flow guiding hole is used to connect receiving space in said bag body to outside.

6. The plant cultivation bag structure as claimed in claim 5, wherein on said opening is provided with a guiding portion in protrusion, to guide water flowing out from said flow guiding hole into said bag body.

7. The plant cultivation bag structure as claimed in claim 1, wherein each said bag body is provided with a machine sewing thread opening or a press mark thread opening.

8. The plant cultivation bag structure as claimed in claim 1, wherein in said bag body is provided with cultivation soil.

9. The plant cultivation bag structure as claimed in claim 1, wherein top portion of said thin main body is provided with a support piece, to put said thin main body into shape, said support piece is of an arc shape, a long strap shape, a multi- section arc shape, or an L shape.

10. The plant cultivation bag structure as claimed in claim 1, wherein said flow guiding holes are placed between adjacent bag bodies, to connect said receiving spaces of two said adjacent bag bodies.

11. The plant cultivation bag structure as claimed in claim 10, further comprising:
a common channel, connected to each said flow guiding hole.

12. The plant cultivation bag structure as claimed in claim 1, wherein bottom of said thin main body further includes at least a water-gathering bag body.

13. The plant cultivation bag structure as claimed in claim 12, further comprising:
a water channel, connected to said upper most bag body and said water-gathering bag body, such that a pump is provided in said water-gathering bag body, with its outlet connected to said water channel, water in said water-gathering bag body is flowed into said upper most bag body through said water channel by means of said pump.

14. The plant cultivation bag structure as claimed in claim 1, wherein between said adjacent bag bodies is provided with a partition space, said
flow guiding hole passes through said partition space to connect said receiving spaces of said adjacent bag bodies.

15. The plant cultivation bag structure as claimed in claim 1, wherein Thermal Pressing, High Frequency Fusion, Ultra-Sonic Fusion, Stick method are used to partition said thin main body into a plurality of bag bodies.
